(19) United States
(12) Patent Application Publication
(10) Pub. No.: US 2011/0261783 A1
(43) Pub. Date: Oct. 27, 2011

(54) RESOURCE ASSIGNMENT METHOD AND MOBILE STATION

(75) Inventors: Junxian Mo, Shenzhen (CN); Jia Lin, Shenzhen (CN); Tao Qian, Shenzhen (CN)

(73) Assignee: Huawei Technologies Co., Ltd., Shenzhen (CN)

(21) Appl. No.: 13/179,031

(22) Filed: Jul. 8, 2011

Related U.S. Application Data
(63) Continuation of application No. PCT/CN2010/070057, filed on Jan. 8, 2010.

(30) Foreign Application Priority Data
Jan. 8, 2010 (CN) 200910076235.8

(51) Int. Cl. H04W 72/04

(52) U.S. Cl. 370/330; 370/329

(57) ABSTRACT

A resource assignment method and a Mobile Station (MS) are provided. The method includes: obtaining, by the MS, combined indication information carried in a resource assignment message after the MS receives the resource assignment message; judging whether a resource block indicated by resource assignment information in the resource assignment message is a segment of a Physical-layer (PHY) Protocol Data Unit (PDU) according to the combined indication information, and reading the segment of the corresponding PHY PDU according to the resource assignment information if the resource block is a segment of the PHY PDU; combining segments belonging to the same PHY PDU into a complete PHY PDU, wherein the segments are read according to multiple received resource assignment messages; and decoding the PHY PDU. The MS includes an obtaining module, a judging module, a reading module, a combining module, and a decoding module. The resource assignment method and the MS facilitate the design of resource assignment messages of one or several uniform formats, and therefore, the resource assignment messages have a fixed size which does not change dynamically with the number of segments, and the complexity and the cost of the MS are reduced.

### CROSS-REFERENCE TO RELATED APPLICATIONS

This application is a continuation of International Application No. PCT/CN2010/070057, filed on Jan. 8, 2010, which claims priority to Chinese Patent Application No. 200910076235.8, filed on Jan. 8, 2009, both of which are hereby incorporated by reference in their entireties.

### TECHNICAL FIELD

The present invention relates to a resource assignment method and a Mobile Station (MS), and belongs to the field of wireless communication technologies.

### BACKGROUND

The Institute of Electrical and Electronics Engineers (IEEE) 802.16 standard series includes seven standards: 802.16, 802.16a, 802.16c, 802.16d, 802.16e, 802.16f, and 802.16g in total so far. 802.16, 802.16a, and 802.16d belong to the air interface standard of fixed wireless access, while 802.16e belongs to the air interface standard of mobile broadband wireless access.

For example, the Worldwide Interoperability for Microwave Access (WiMAX) in the prior art is a wireless Metropolitan Area Network (MAN) technology, and is a broadband wireless connection solution which provides “last mile” for enterprises and home users. This technology is based on 802.16 series of broadband wireless standards, and uses the 802.16 standard series as its air interface protocol.

The multi-carriers technology in the prior art enables upgrade and extension of system bandwidth. In such a multi-carriers system, the whole bandwidth is divided into multiple carriers. For example, 100 MHZ bandwidth is divided into four carriers, and each carrier occupies 20 MHZ bandwidth. In a multi-carriers case, a Protocol Data Unit (PDU) of a physical layer (PHY) is divided into multiple segments, which are transmitted over multiple carriers. A PHY PDU undergoes channel coding, modulation, and Multi Input Multi Output (MIMO) coding, and generates a modulated signal sequence, which is transmitted over one of the multiple carriers; or, the modulated signal sequence may be divided into segments first, which are transmitted over multiple carriers. As regards the PDUs on the same PHY, the Modulation Code Scheme (MCS) and the MIMO configuration for all segments after segment division are the same.

In an existing communication system, resource assignment messages exist, and are used to assign MS Identifier (ID) information, location info/nation of resource blocks, size information of resource blocks, MCS information, and multi-antenna info/nation to an MS. In the single-carrier communication technology in the prior art, a Base Station (BS) uses a resource assignment message to indicate information about the location of a PHY PDU, the size of the PHY PDU, the MCS, and the ID of the MS that needs to receive the PDU; and the MS reads the corresponding PHY PDU according to the resource assignment information in the resource assignment message.

In the broadband communication technology in the prior art, a PHY PDU is split into multiple segments, each of which is transmitted simultaneously over different carriers. The MS still needs to read multiple segments belonging to the same PHY PDU through resource assignment messages. The practice in the prior art is: The same resource assignment message includes resource assignment information of multiple segments of the same PHY PDU. Because the size of a resource assignment message depends on the number of segments of the PHY PDU, this practice leads to dynamic change of the size of the resource assignment message, namely, if the PHY PDU is split into more segments, more resource assignment information is required, and accordingly, the size of the whole resource assignment message is greater. This practice requires the MS to have the capability of processing resource assignment messages in different sizes, so as to impose higher requirements on the demodulation capability of the MS, thereby increasing design complexity and cost of the MS. Moreover, for the operation of detecting the resource assignment messages by the MS, the workload increases exponentially, thereby greatly increasing the work burden of the MS.

### SUMMARY

The embodiments of the present invention provide a resource assignment method and an MS, so that the size of resource assignment messages does not dynamically change, so as to reduce complexity and cost of the MS.

To achieve the foregoing purpose, an embodiment of the present invention provides a resource assignment method, where the resource assignment method includes:

obtaining, by an MS, combined indication information carried in a resource assignment message after the MS receives the resource assignment message;

judging whether a resource block indicated by resource assignment info nation in the resource assignment message is a segment of a PHY PDU according to the combined indication information, and reading the segment of the corresponding PHY PDU according to the resource assignment information if the resource block is a segment of the PHY PDU;

combining segments belonging to a same PHY PDU into a complete PHY PDU, wherein the segments are read according to multiple received resource assignment messages; and

decoding the PHY PDU.

To achieve the foregoing purpose, another embodiment of the present invention provides an MS, where the MS includes:

an obtaining module, configured to obtain combined indication information carried in a resource assignment message after the MS receives the resource assignment message;

a judging module, configured to judge whether a resource block indicated by resource assignment information in the resource assignment message is a segment of a PHY PDU according to the combined indication information obtained by the obtaining module;

a reading module, configured to read the segment of the corresponding PHY PDU according to the resource assignment information if the indicated resource block is a segment of the PHY PDU according to a judgment result of the judging module;

a combining module, configured to combine segments belonging to a same PHY PDU into a complete PHY PDU, wherein the segments are read according to multiple received resource assignment messages; and

a decoding module, configured to decode the PHY PDU combined by the combining module.

Through the embodiments of the present invention, combined indication information is added into the existing resource assignment message, so that the MS knows that the resource block indicated by the resource assignment message is a segment of a PHY PDU, and then combines and decodes multiple segments so as to achieve the purpose of resource assignment. Therefore, one resource assignment message is not required to include all resource assignment information of the multiple segments belonging to the same PHY PDU, thereby advantageously designing resource assignment messages of one or several uniform formats, so that the resource assignment messages have a fixed size which does not change dynamically with the number of segments, so as to reduce the workload of detecting the assignment messages by the MS and reduce complexity and cost of the MS.

The technical solution under the present invention is further described in detail below with reference to accompanying drawings and embodiments.

### BRIEF DESCRIPTION OF THE DRAWINGS

FIG. 1 is a flowchart of a resource assignment method according to a first embodiment of the present invention;

FIG. 2 is a flowchart of a resource assignment method according to a second embodiment of the present invention;

FIG. 3 is a flowchart of a resource assignment method according to a third embodiment of the present invention;

FIG. 4 is a flowchart of a resource assignment method according to a fourth embodiment of the present invention;

FIG. 5 is a flowchart of a resource assignment method according to a fifth embodiment of the present invention;

FIG. 6 is a flowchart of a resource assignment method according to a sixth embodiment of the present invention;

FIG. 7 is a flowchart of a resource assignment method according to a seventh embodiment of the present invention;

FIG. 8 is a flowchart of a resource assignment method according to an eighth embodiment of the present invention;

FIG. 9 is a flowchart of a resource assignment method according to a ninth embodiment of the present invention;

FIG. 10 is a flowchart of a resource assignment method according to a tenth embodiment of the present invention; and

FIG. 11 is a schematic application diagram of an MS according to an embodiment of the present invention.

### DETAILED DESCRIPTION

### Method Embodiment 1

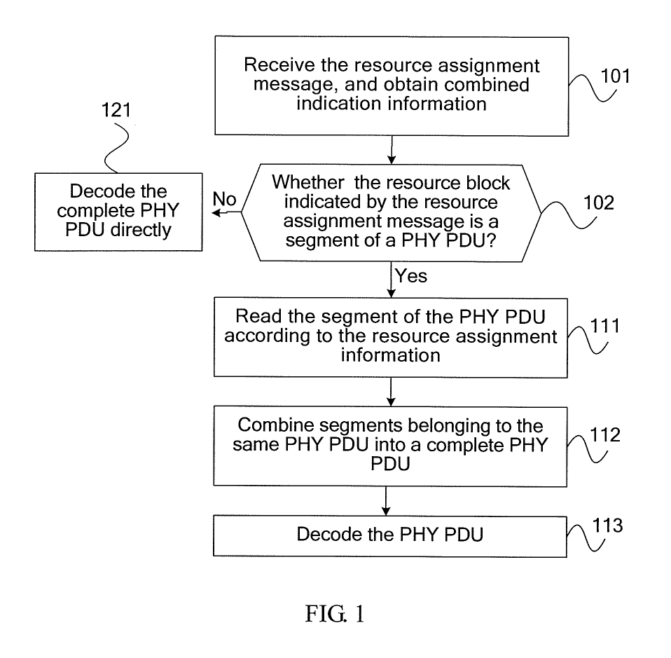

This embodiment provides a resource assignment method. As shown in FIG. 1, the method includes the following steps:

Step 101: An MS obtains combined indication information carried in a resource assignment message after the MS receives the resource assignment message.

The combined indication information is used to indicate whether a resource block indicated by resource assignment information in the resource assignment message is a complete PHY PDU or a segment of a PHY PDU. Specifically, the combined indication information may be a combined indication field added into the resource assignment message, or may be MCS information in the resource assignment information in the resource assignment message.

The MCS information is used to indicate the MCS of the corresponding resource block to the MS. When the MS receives multiple resource assignment messages at the same time (namely, in the same frame), different MCS information corresponds to different PHY PDUs, and the same MCS information corresponds to the same PHY PDU. Therefore, if the MS receives multiple resource assignment messages that carry the same MCS information, the MS knows that the resource blocks indicated by the resource assignment messages are segments of the same PHY PDU.

Step 102: Judge whether the resource block indicated by resource assignment information in the resource assignment message is a segment of a PHY PDU according to the combined indication information; if the resource block is a segment of the PHY PDU, the procedure proceeds to step 111; if the resource block is not a segment of the PHY PDU, the procedure proceeds to step 121.

Step 111: Read the segment of the corresponding PHY PDU according to the resource assignment information if the resource block indicated by the resource assignment message is a segment of the PHY PDU, and then the procedure proceeds to step 112.

Step 112: Combine segments belonging to the same PHY PDU into a complete PHY PDU, wherein the segments are read according to multiple received resource assignment messages.

Step 113: Decode the PHY PDU.

Step 121: If the resource block indicated by the resource assignment message is not a segment of the PHY PDU but is a complete PHY PDU, the complete PHY PDU is decoded directly.

Through the method according to this embodiment, combined indication information is added into the existing resource assignment message; therefore, the MS knows that the resource block indicated by the resource assignment message is a segment of the PHY PDU, and then combines and decodes multiple segments so as to achieve the purpose of resource assignment. Therefore, one resource assignment message is not required to include all resource assignment information of the multiple segments belonging to the same PHY PDU, thereby advantageously designing resource assignment messages of one or more uniform formats, so that the resource assignment messages have a fixed size which does not change dynamically with the number of segments, so as to reduce the workload of detecting the assignment messages by the MS and reduce complexity and cost of the MS.

### Method Embodiment 2

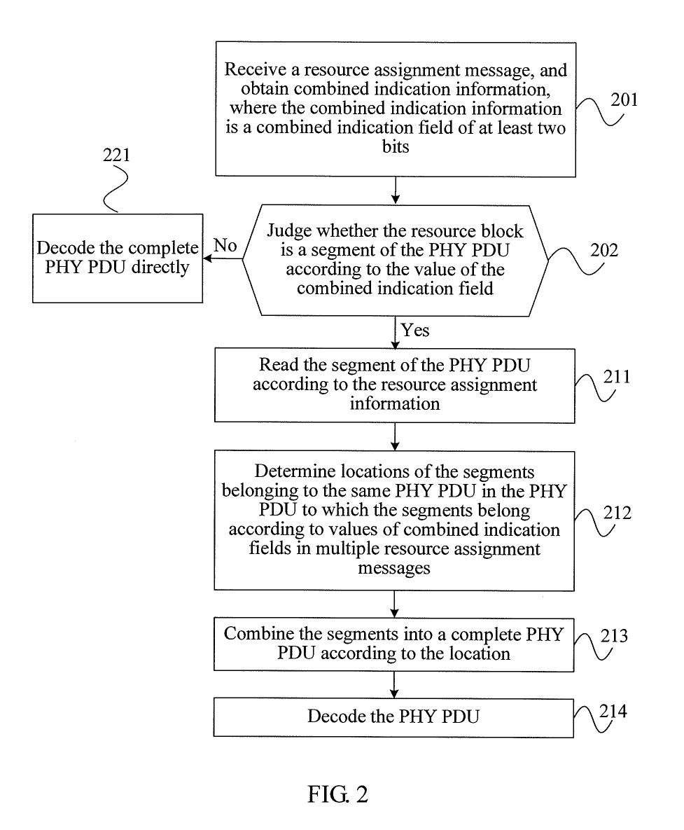

This embodiment provides another resource assignment method. As shown in FIG. 2, the method includes the following steps:

Step 201: An MS obtains combined indication information carried in a resource assignment message after the MS receives the resource assignment message. The combined indication information is a combined indication field of at least two bits.

Multiple values of the combined indication field may not only indicate whether the resource block indicated by resource assignment information in the resource assignment message is a segment of a PHY PDU or a complete PHY PDU, but also may indicate the location of the segment in the PHY PDU to which the segment belongs.

Step 202: Judge whether the resource block indicated by the resource assignment information in the resource assignment message is a segment of a PHY PDU according to the value of the combined indication field; if the resource block is a segment of the PHY PDU, the procedure proceeds to step 211; if the resource block is not a segment of the PHY PDU, the procedure proceeds to step 221.

For example, it is assumed that the combined indication information is a combined indication field of two bits. The following rule may be preset: If the value of this field is 0x00, it indicates that the resource block indicated by the resource assignment message is a complete PHY PDU; if the value of this field is not 0x00, it indicates that the resource block is a segment of the PHY PDU.

Step 211: Read the segments of the corresponding PHY PDU according to the resource assignment information if the resource block indicated by the resource assignment message is a segment of the PHY PDU, and then the procedure proceeds to step 212.

Step 212: Determine locations of the segments belonging to the same PHY PDU in the PHY PDU to which the segments belong according to the values of combined indication fields in multiple resource assignment messages.

For example, it is assumed that the combined indication information is a combined indication field of two bits. The following rule may be preset:

If the value of this field is 0x01, it indicates that the resource block indicated by the resource assignment message is a segment of a PHY PDU, and the segment is the first part of the corresponding PHY PDU.

If the value of this field is 0x10, it indicates that the resource block indicated by the resource assignment message is a segment of a PHY PDU, and the segment is the continued part of the corresponding PHY PDU.

If the value of this field is 0x11, it indicates that the resource block indicated by the resource assignment message is a segment of a PHY PDU, and the segment is the last part of the corresponding PHY PDU.

Besides, the combined indication information may also be a combined indication field of more than two bits, and may have a preset value as an end indicator. The end indicator is used to indicate that the segment is the last part of the corresponding PHY PDU and is followed by no segment. The preset value may be all 0s or all 1s, for example, 0x000 . . . 00, or 0x111 . . . 11.

Step 213: Combine the segments into a complete PHY PDU according to the locations.

Step 214: Decode the PHY PDU.

Step 221: If the resource block indicated by the resource assignment message is not a segment of the PHY PDU but is a complete PHY PDU, the complete PHY PDU is decoded directly.

Through the method according to this embodiment, a combined indication field of at least two bits is selected as combined indication information; not only whether the resource block is a segment of a PHY PDU is judged, but also the locations of the segments belonging to the same PHY PDU in this PHY PDU are determined, thereby providing an optional implementation mode of judging and combining segments.

### Method Embodiment 3

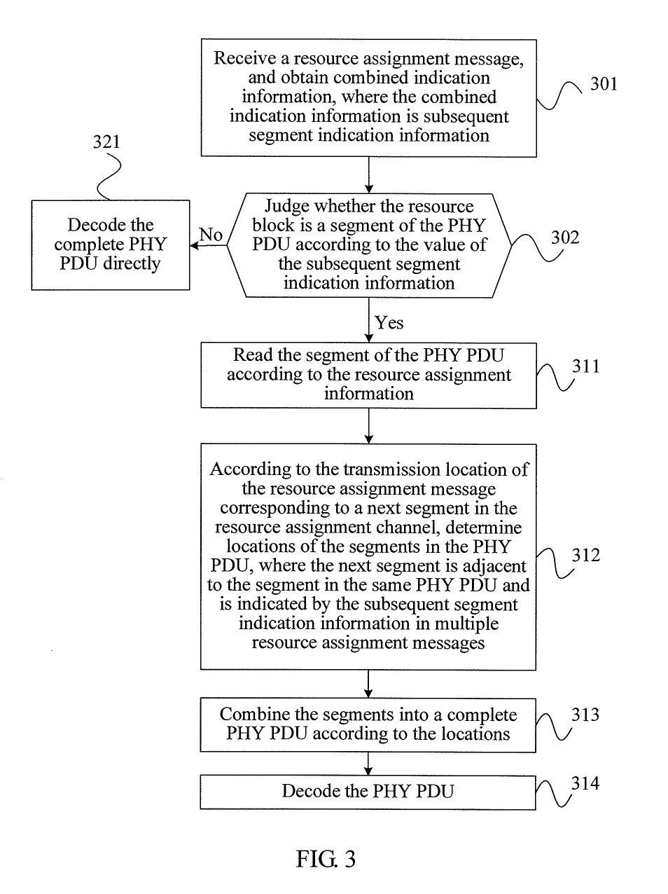

This embodiment provides another resource assignment method. As shown in FIG. 3, the method includes the following steps:

Step 301: An MS obtains combined indication information carried in a resource assignment message after the MS receives the resource assignment message. The combined indication information is subsequent segment indication information.

The subsequent segment indication information not only may indicate whether the resource block indicated by resource assignment information in the resource assignment message is a segment of a PHY PDU or a complete PHY PDU, but also may indicate the transmission location of the resource assignment message corresponding to a next segment in the resource assignment channel, where the next segment is adjacent to the segment in the same PHY PDU. Besides, the subsequent segment indication information may have a preset value as an end indicator. The end indicator is used to indicate that the segment is the last part of the corresponding PHY PDU and is followed by no segment.

Step 302: Judge whether the resource block indicated by resource assignment information in the resource assignment message is a segment of a PHY PDU according to the subsequent segment indication information; if the resource block is a segment of the PHY PDU, the procedure proceeds to step 311; if the resource block is not a segment of the PHY PDU, the procedure proceeds to step 321.

If the subsequent segment indication information indicates that the corresponding segment has no adjacent next segment, and the segment itself is not the last segment, it indicates that the resource block indicated by the resource assignment message is a complete PHY PDU rather than a segment of a PHY PDU; if the subsequent segment indication information indicates that the corresponding segment has an adjacent next segment, it indicates that the resource block is a segment of a PHY PDU.

Step 311: Read the segments of the corresponding PHY PDU according to the resource assignment information if the resource block indicated by the resource assignment message is a segment of the PHY PDU, and then the procedure proceeds to step 312.

Step 312: According to the transmission location of the resource assignment message corresponding to a next segment in the resource assignment channel, locations of the segments belonging to the same PHY PDU in the PHY PDU to which the segments belong are determined, where the next segment is adjacent to the segment in the same PHY PDU and is indicated by the subsequent segment indication information in multiple resource assignment messages.

For example, if the segment corresponding to a resource assignment message is segment 1, according to subsequent segment indication information in the resource assignment message, the MS knows the transmission location of a resource assignment message corresponding to a next segment in the resource assignment channel, where the next segment is adjacent to segment 1, namely, the next segment is segment 2. For example, it is assumed that the transmission location of segment 2 is determined by the second time-frequency resource block of the first carrier, so that the MS knows that segment 2 obtained on this location is a next segment adjacent to segment 1, and determines that the arrangement location of segment 1 and segment 2 in one PHY PDU is segment 1→segment 2.

Step 313: Combine the segments into a complete PHY PDU according to the locations.

Step 314: Decode the PHY PDU.

Step 321: If the resource block indicated by the resource assignment message is not a segment of the PHY PDU but is a complete PHY PDU, the complete PHY PDU is decoded directly.

Through the method according to this embodiment, subsequent segment indication information is selected as combined indication information; not only whether the resource block is a segment of a PHY PDU is judged, but also the locations of the segments belonging to the same PHY PDU in this PHY PDU are determined, thereby providing another optional implementation mode of judging and combining segments.

### Method Embodiment 4

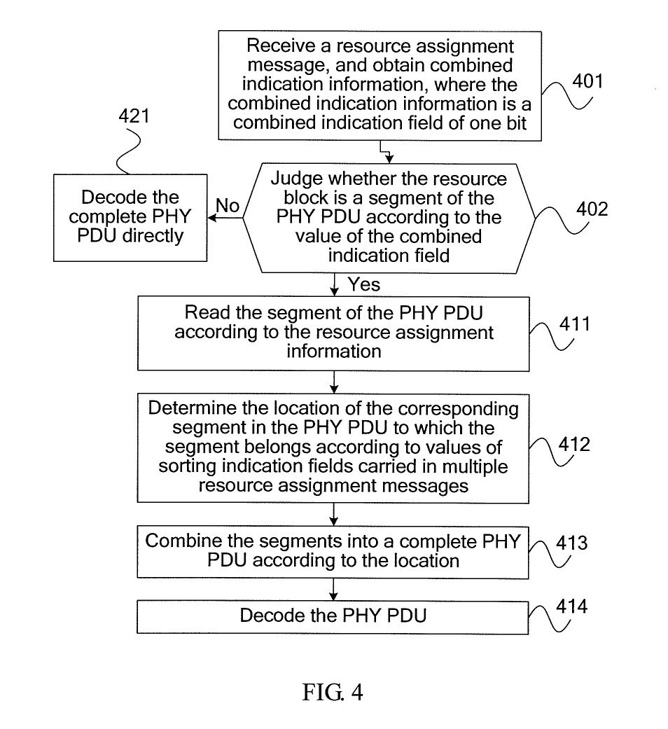

This embodiment provides another resource assignment method. As shown in FIG. 4, the method includes the following steps:

Step 401: An MS obtains combined indication information carried in a resource assignment message after the MS receives the resource assignment message. The combined indication information is a combined indication field of one bit.

Two values of the combined indication field indicate whether the resource block indicated by resource assignment information in the resource assignment message is a segment of a PHY PDU or a complete PHY PDU respectively.

Step 402: Judge whether the resource block indicated by the resource assignment information in the resource assignment message is a segment of a PHY PDU according to the value of the combined indication field; if the resource block is a segment of the PHY PDU, the procedure proceeds to step 411; if the resource block is not a segment of the PHY PDU, the procedure proceeds to step 421.

For example, the following rule may be preset: If the value of the combined indication field is 0, it indicates that the resource block indicated by the resource assignment message is a complete PHY PDU; if the value of the combined indication field is 1, it indicates that the resource block indicated by the resource assignment message is a segment of a PHY PDU.

Step 411: Read the segments of the corresponding PHY PDU according to the resource assignment information if the resource block indicated by the resource assignment message is a segment of the PHY PDU, and then the procedure proceeds to step 412.

Step 412: Determine the location of the corresponding segment in the PHY PDU to which the segment belongs according to the values of sorting indication fields respectively carried in multiple received resource assignment messages.

In this embodiment, each resource assignment message carries not only a combined indication field of one bit, but also a sorting indication field. The values of the sorting indication field may be 1, 2, 3, and so on, which are used to indicate the location of the segment corresponding to the resource assignment message in the PHY PDU to which the segment belongs.

Step 413: Combine the segments into a complete PHY PDU according to the location.

Step 414: Decode the PHY PDU.

Step 421: If the resource block indicated by the resource assignment message is not a segment of the PHY PDU but is a complete PHY PDU, the complete PHY PDU is decoded directly.

Through the method according to this embodiment, a combined indication field of one bit is carried in the resource assignment message so as to judge whether the resource block is a segment of a PHY PDU, and a sorting indication field is carried in the resource assignment message so as to determine the locations of the segments belonging to the same PHY PDU in this PHY PDU, thereby providing another optional implementation mode of judging and combining segments.

### Method Embodiment 5

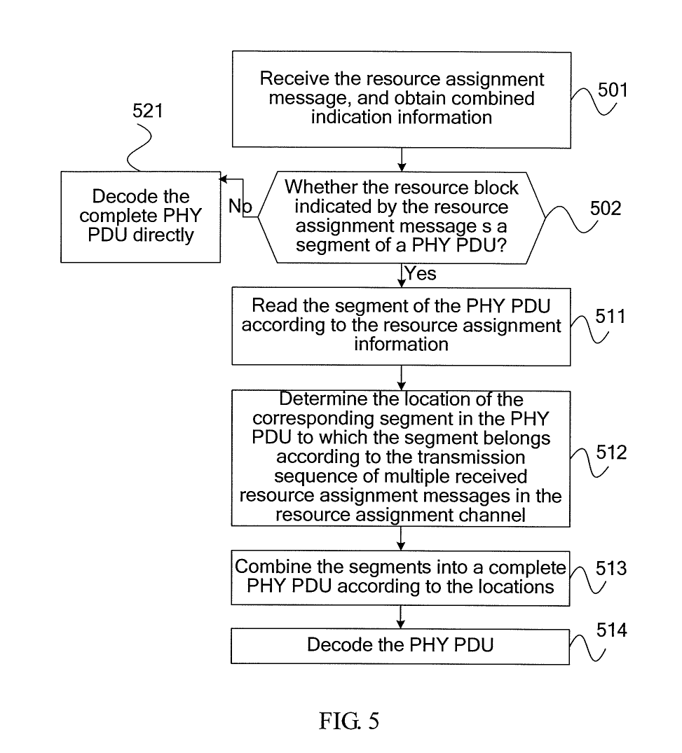

This embodiment provides another resource assignment method. As shown in FIG. 5, the method includes the following steps:

Step 501, step 502, step 511, and step 521 in this embodiment are the same as step 101, step 102, step 111, and step 121 in the first method embodiment respectively, and are not repeated herein. The difference between the two embodiments lies in the following steps:

Step 512: Determine the location of the corresponding segment in the PHY PDU to which the corresponding segment belongs according to the transmission sequence of multiple received resource assignment messages in the resource assignment channel.

The resource assignment messages are transmitted in certain sequence in the resource assignment channel. Therefore, the MS and the BS may stipulate beforehand to determine the locations of the corresponding segments in the PHY PDU to which the corresponding segments belong according to the transmission sequence of the resource assignment messages in the resource assignment channel. The resource assignment messages may be continuous or discontinuous in the resource assignment channel.

Step 513: Combine the segments into a complete PHY PDU according to the locations.

Step 514: Decode the PHY PDU.

Through the method according to this embodiment, combined indication information is carried in the resource assignment message so as to judge whether the resource block is a segment of a PHY PDU; the locations of the segments belonging to the same PHY PDU in this PHY PDU are determined according to the transmission sequence of multiple resource assignment messages in the resource assignment channel, thereby providing another optional implementation mode of judging and combining segments.

### Method Embodiment 6

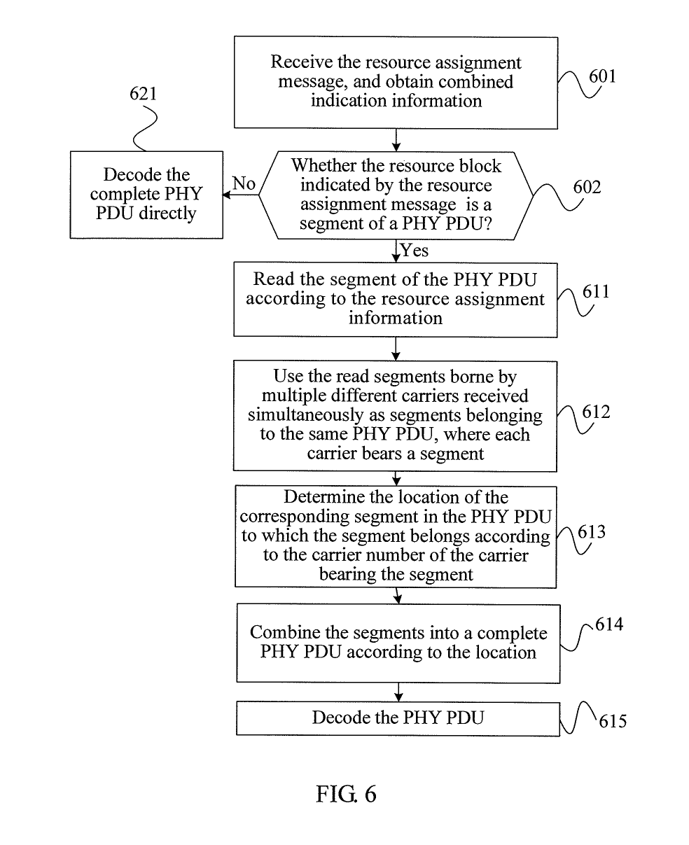

This embodiment provides another resource assignment method. As shown in FIG. 6, the method includes the following steps:

Step 601, step 602, step 611, and step 621 in this embodiment are the same as step 101, step 102, step 111, and step 121 in the first method embodiment respectively, and are not repeated herein. The difference between the two embodiments lies in the following steps:

Step 612: Use the read segments borne respectively by multiple different carriers received simultaneously as segments belonging to the same PHY PDU, where each carrier bears a segment.

In this embodiment, each carrier bears one segment. If an MS of a receiving party receives such carriers simultaneously, the MS determines that the segments borne over such carriers belong to the same PHY PDU.

Step 613: Determine the location of the corresponding segment in the PHY PDU to which the corresponding segment belongs according to the carrier number of the corresponding carrier that bears the segment.

Specifically, the MS and the BS may stipulate beforehand or negotiate through an air interface message dynamically to set the mapping relation between the carrier number of the carrier and the location of the segment borne by the carrier in the PHY PDU to which the segment belongs, and then the MS determines the location of the corresponding segment in the PHY PDU to which the corresponding segment belongs according to the mapping relation.

Step 614: Combine the segments into a complete PHY PDU according to the location.

Step 615: Decode the PHY PDU.

Through the method according to this embodiment, combined indication information is carried in the resource assignment message so as to judge whether the resource block is a segment of a PHY PDU, and the locations of the segments belonging to the same PHY PDU in this PHY PDU are determined according to the mapping relation between the carrier number of the carrier and the location of the segment borne by the carrier in the PHY PDU, thereby providing another optional implementation mode of judging and combining segments.

### Method Embodiment 7

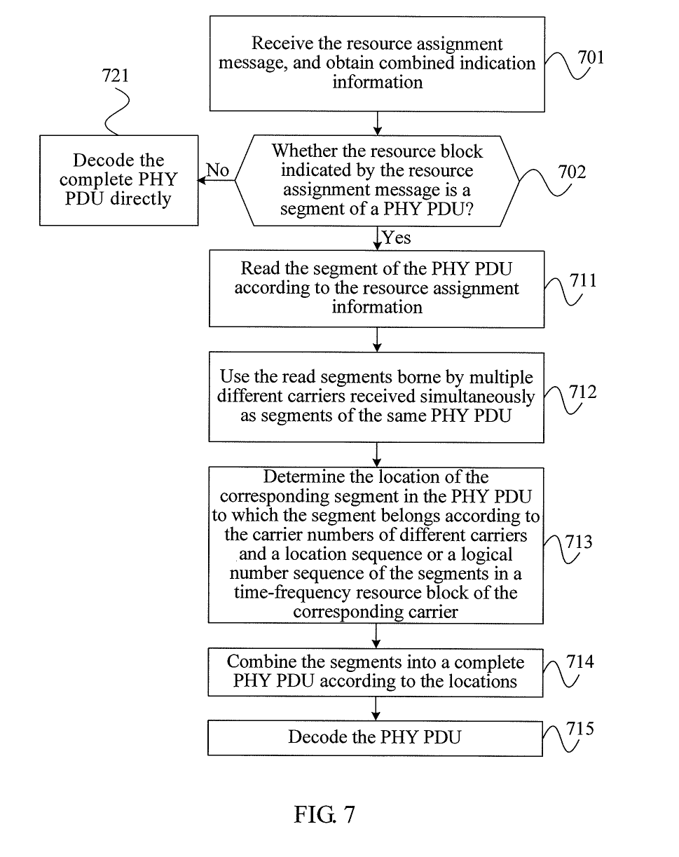

This embodiment provides another resource assignment method. As shown in FIG. 7, the method includes the following steps:

Step 701, step 702, step 711, and step 721 in this embodiment are the same as step 101, step 102, step 111, and step 121 in the first method embodiment respectively, and are not repeated herein. The difference between the two embodiments lies in the following steps:

Step 712: Use the read segments borne respectively by multiple different carriers received simultaneously as segments belonging to the same PHY PDU.

In this embodiment, the segments are transmitted in a multi-carriers communication mode. That is, at the same time, segments belonging to the same PHY PDU are borne on multiple different carriers for transmission. If multiple segments read by an MS of a receiving party are borne by multiple carriers respectively at the same time, the MS determines that the segments belong to the same PHY PDU.

Step 713: Determine the location of the corresponding segment in the PHY PDU to which the corresponding segment belongs according to carrier numbers of the different carriers, and the location sequence or the logical number sequence of the time-frequency resource block of the carrier corresponding to the segment.

Step 714: Combine the segments into a complete PHY PDU according to the locations.

Step 715: Decode the PHY PDU.

For example, it is assumed that Table 1, Table 2, and Table 3 show content borne by the time-frequency resource block of carrier 1, carrier 2, and carrier 3. Carrier 1 bears segment 1, segment 2, and segment 3; carrier 2 bears segment 4, segment 5, and segment 6; and carrier 3 bears segment 7, segment 8, and segment 9. Such segments belong to the same PHY PDU.

TABLE 1

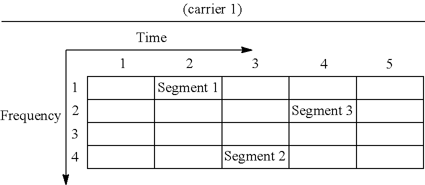

TABLE 2

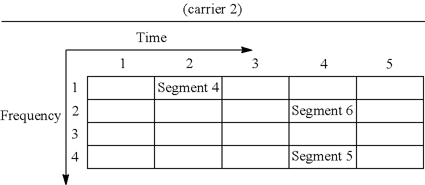

TABLE 3

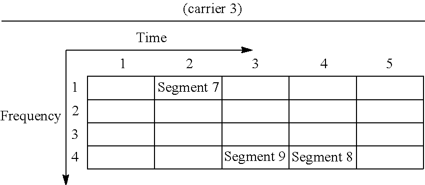

When the locations of segments 1 to 9 in the PHY PDU are determined, the sequence of the segment is determined according to the carrier number of each carrier. For example, segments 1 to 3 borne by carrier 1 are arranged in the most front of the PHY PDU; segments 4 to 6 borne by carrier 2 are arranged after segments 1 to 3; and segments 7 to 9 borne by carrier 3 are arranged after segments 4 to 6.

Afterward, the sequence of the segment is further determined according to the location sequence of the time-frequency resource block of the carrier corresponding to the segments, or the logical number sequence of the time-frequency resource block corresponding to the segments. Specifically, the location sequence of the segment in the time-frequency resource block may be determined according to the sequence from the time domain to the frequency domain, or from the frequency domain to the time domain, or sorted according to the logical number sequence of the time-frequency resource block directly. Specifically, which sequence is selected to determine the sorting location may be set by stipulation between the MS and the BS beforehand, or set by dynamic negotiation between the MS and the BS through an air interface message.

For example, if the locations of the segments are determined according to the sequence from the time domain to the frequency domain, the locations determined according to Table 1 is: segment 1→segment 2→segment 3; the locations determined according to Table 2 is: segment 4→segment 6→segment 5; and the locations determined according to Table 3 is: segment 7→segment 9→segment 8.

Finally, the determined locations of segments 1 to 9 in the PHY PDU is: segment 1→segment 2→segment 3→segment 4→segment 6→segment 5→segment 7→segment 9→segment 8. According to the sequence, segments 1 to 9 are combined into a complete PHY PDU, and then the decoding is implemented successfully.

Through the method according to this embodiment, combined indication information is carried in the resource assignment message so as to judge whether the resource block is a segment of a PHY PDU; the locations of the segments belonging to the same PHY PDU in this PHY PDU are determined according to the preset mapping relation between the carrier and the segment, thereby providing another optional implementation mode of judging and combining segments.

It should be noted that the meanings of the different values of the combined indication field listed above are for the exemplary purpose only, and different meanings may be set for the different values as long as the sending party and the receiving party negotiate and achieve consistency. For example, the values may have the following meanings: If the value of the combined indication field is 1, it indicates that the resource block indicated by the resource assignment message is a complete PHY PDU; if the value of the combined indication field is 0, it indicates that the resource block indicated by the resource assignment message is a segment of a PHY PDU.

### Method Embodiment 8

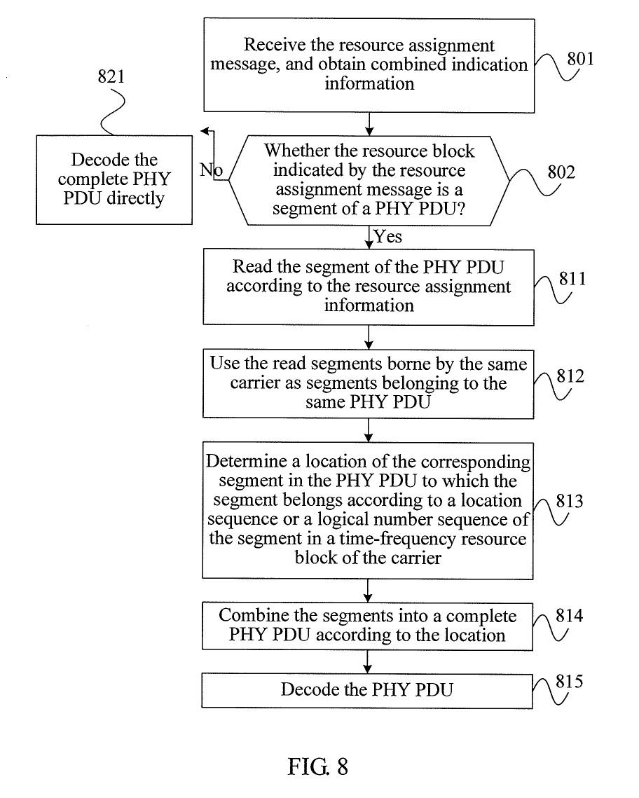

This embodiment provides another resource assignment method. As shown in FIG. 8, the method includes the following steps:

Step 801, step 802, step 811, and step 821 in this embodiment are the same as step 101, step 102, step 111, and step 121 in the first method embodiment respectively, and are not repeated herein. The difference between the two embodiments lies in the following steps:

Step 812: Use the read segments borne by the same carrier as segments belonging to the same PHY PDU.

In this embodiment, segments belonging to the same PHY PDU are borne on the same carrier for transmission. If multiple segments read by an MS of the receiving party are borne by the same carrier, the MS determines that the segments belong to the same PHY PDU.

Step 813: Determine the location of the corresponding segment in the PHY PDU to which the corresponding segment belongs according to the location sequence of the time-frequency resource block of the carrier corresponding to the segment or the logical number sequence of the time-frequency resource block.

This embodiment mainly differs from the seventh method embodiment in that: All segments belonging to the same PHY PDU are borne by one carrier, and therefore, the locations of the segments in the PHY PDU may be determined according to only the sequence of the locations of the segments in the time-frequency resource block of the carrier. The specific example refers to the seventh embodiment above, and is not repeated herein.

Step 814: Combine the segments into a complete PHY PDU according to the location.

Step 815: Decode the PHY PDU.

Through the method according to this embodiment, combined indication information is carried in the resource assignment message so as to judge whether the resource block is a segment of a PHY PDU; the locations of the segments belonging to the same PHY PDU in this PHY PDU are determined according to the preset mapping relation between the carrier and the segment, thereby providing another optional implementation mode of judging and combining segments.

### Method Embodiment 9

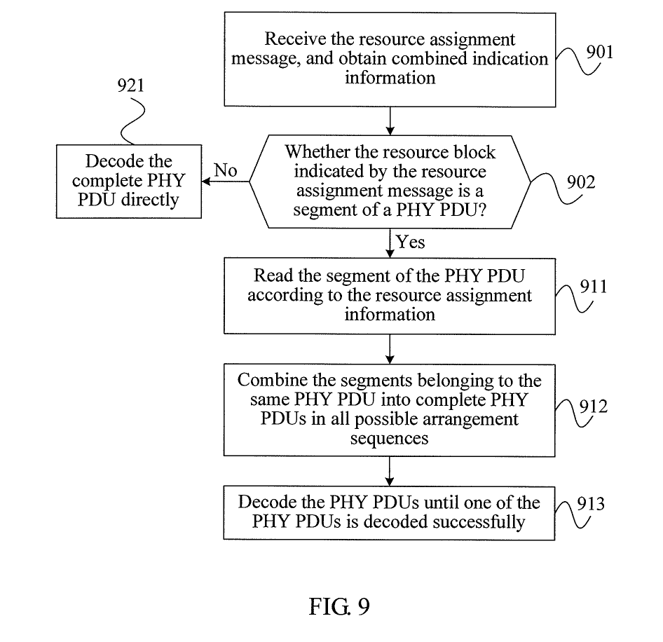

This embodiment provides another resource assignment method. As shown in FIG. 9, the method includes the following steps:

Step 901, step 902, step 911, and step 921 in this embodiment are the same as step 101, step 102, step 111, and step 121 in the first method embodiment respectively, and are not repeated herein. The difference between the two embodiments lies in the following steps:

Step 912: Combine the segments belonging to the same PHY PDU into complete PHY PDUs respectively in all possible arrangement sequences.

Step 913: Decode the PHY PDUs until one of the PHY PDUs is decoded successfully.

For example, in the example given in the first method embodiment above, if the value of the combined indication field of 2 bits is 0x01, it indicates that the corresponding segment is the first segment of the corresponding PHY PDU; if the value of the combined indication field is 0x11, it indicates that the corresponding segment is the last segment of the PHY PDU. However, if the PHY PDU includes four segments in total, the arrangement sequence of the two segments in the middle still cannot be determined. In this case, the following decoding mode is applicable:

The two segments in the middle are named “A” and “B”. In this case, because the location relation of the two segments in the middle is uncertain, the resource assignment information needs to be decoded blindly twice. That is, combining is performed in a 0x01+0x10(A)+0x10(B)+0x11 mode first and then decoding is performed; if the decoding fails, combining is performed in a 0x01+0x10(B)+0x10(A)+0x11 mode and then decoding is performed until the decoding succeeds.

It should be noted that, the method of judging success or failure in the decoding varies with the system. For example, the judgment may be made by checking the Cyclical Redundancy Check (CRC) according to the Media Access Control (MAC) ID of the user.

In this embodiment, the MS decodes the resource assignment information blindly to solve the problem occurring when the segments in the PHY PDU are sorted. Therefore, the resource assignment message does not need to include any information which is used to indicate the location of the corresponding segment in the PHY PDU to which the corresponding segment belongs. Therefore, the size of the resource assignment message is further reduced. If there are many segments, the number of times of blind decoding increases greatly. Therefore, this embodiment is more applicable when the number of segments is small.

### Method Embodiment 10

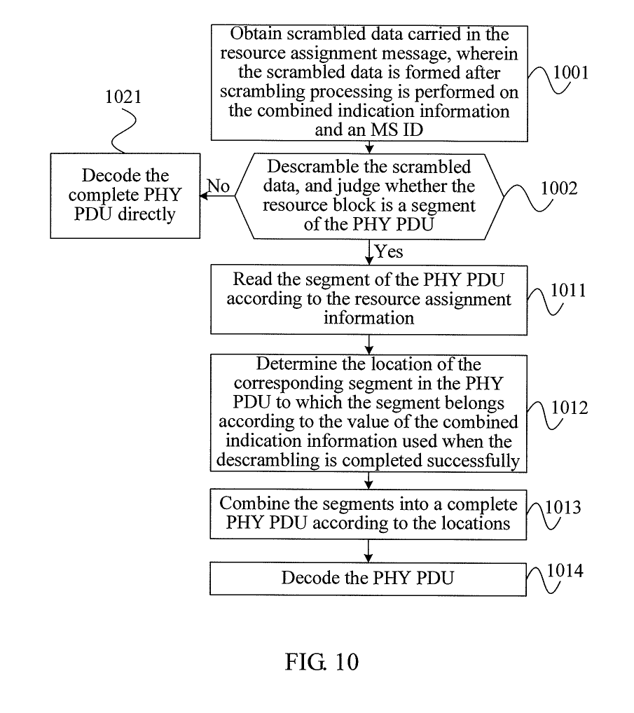

This embodiment provides another resource assignment method. As shown in FIG. 10, the method includes the following steps:

Step 1021 is the same as step 121 in the first method embodiment above, and is not repeated herein. The difference between the two embodiments lies in the following steps:

Step 1001: After receiving the resource assignment message, the MS obtains scrambled data carried in the resource assignment message, where the scrambled data is formed after scrambling processing is performed on the combined indication information and the MS ID.

In the prior art, the MS judges whether the resource assignment message is sent to this MS according to the MS ID carried in the resource assignment message, such as a station ID or basic Connection ID (CID). However, in some systems, in order to reduce the overhead of the resource assignment message and ensure security, the sending party performs the scrambling processing on the resource assignment message, for example, performs CRC operation on the MS ID. Through this method, when the MS traverses resource assignment messages, the MS attempts to descramble each resource assignment message by using its own MAC ID, for example, perform CRC. If the CRC succeeds, it is regarded that the resource assignment message is destined for this MS itself.

In this step, the scrambling processing is performed on the combined indication information and the MS ID together to generate a scrambled data packet.

Step 1002: The scrambled data is descrambled according to the MS ID of the MS and all possible values of the combined indication information. If the descrambling succeeds, it indicates that the resource assignment message is sent to the MS. Furthermore, according to the value of the combined indication information used when the descrambling is completed successfully, whether the resource block is a segment of a PHY PDU can be judged. If the resource block is a segment of the PHY PDU, the procedure proceeds to step 1011; the resource block is not a segment of the PHY PDU, the procedure proceeds to step 1021. The specific judgment mode may refer to the method embodiments above, and is not repeated herein.

Step 1011: Read the segments of the corresponding PHY PDU according to the resource assignment information if the resource block indicated by the resource assignment message is a segment of the PHY PDU, and then the procedure proceeds to step 1012.

Step 1012: Determine the location of the corresponding segment in the PHY PDU to which the corresponding segment belongs according to the value of the combined indication information used when the descrambling is completed successfully. The specific location determination mode may refer to the method embodiments above, and is not repeated herein.

Step 1013: Combine the segments into a complete PHY PDU according to the locations.

Step 1014: Decode the PHY PDU.

See also the example given in the second method embodiment.

When the MS uses MAC ID+0x00 to perform CRC on the resource assignment message successfully, it indicates that the resource assignment message is destined for the MS, and that a complete PHY PDU is assigned.

When the MS uses MAC ID+0x01 to perform CRC on the resource assignment message successfully, it indicates that the resource assignment message is destined for the MS, and that the first part of a PHY PDU is assigned.

When the MS uses MAC ID+0x10 to perform CRC on the resource assignment message successfully, it indicates that the resource assignment message is destined for the MS, and that the continued part of a PHY PDU is assigned.

When the MS uses MAC ID+0x11 to perform CRC on the resource assignment message successfully, it indicates that the resource assignment message is destined for the MS, and that the last part of a PHY PDU is assigned.

Through the method according to this embodiment, after the MS performs descrambling, the MS knows whether the resource assignment message is sent to the MS according to the MS ID, and whether the corresponding resource block is a segment, so as to simplify the processing procedure.

### MS Embodiment

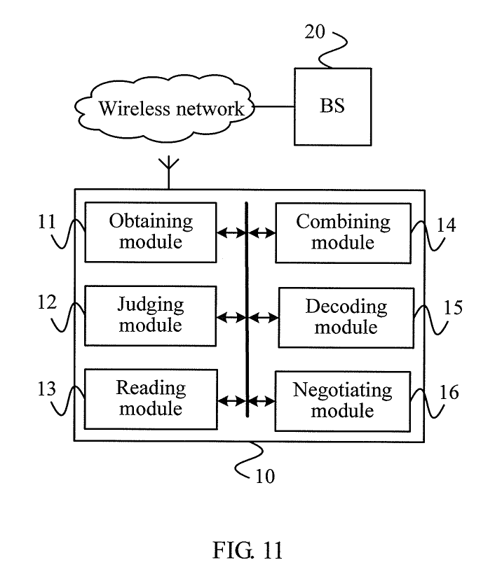

This embodiment provides an MS. As shown in FIG. 11, the MS 10 can exchange information with a BS 20. The MS 10 includes an obtaining module 11, a judging module 12, a reading module 13, a combining module 14, and a decoding module 15. The working principles of the modules are described below:

After the MS 10 receives the resource assignment message sent by the BS 20, the obtaining module 11 of the MS 10 obtains the combined indication information carried in the resource assignment message; the judging module 12 judges whether the resource block indicated by resource assignment information in the resource assignment message is a segment of a PHY PDU according to the combined indication information obtained by the obtaining module 11; the reading module 13 reads the segment of the corresponding PHY PDU according to the resource assignment information if the indicated resource block is a segment of the PHY PDU according to a judgment result of the judging module 12; the combining module 14 combines segments belonging to the same PHY PDU into a complete PHY PDU, wherein the segments are read by the reading module 13 according to multiple received resource assignment messages; and then the decoding module 15 decodes the PHY PDU combined by the combining module 14. The specific combination mode and decoding mode may refer to the method embodiments above, and are not repeated herein.

Besides, the MS 10 may further include a negotiating module 16. The negotiating module 16 of the MS 10 and BS 20 may stipulate beforehand or negotiate through an air interface message dynamically to set the mapping relation between the carrier number of the carrier and the location of the segment borne by the carrier in the PHY PDU to which the segment belongs, so that the combining module 14 can determine the location of the corresponding segment in the PHY PDU to which the segment belongs according to the mapping relation, and combine the segments into a complete PHY PDU.

Through the MS according to this embodiment, combined indication information is added into the existing resource assignment message; therefore, the MS knows that the resource block indicated by the resource assignment message is a segment of the PHY PDU, and then combines and decodes multiple segments so as to achieve the purpose of resource assignment. Therefore, one resource assignment message is not required to include all resource assignment information of multiple segments belonging to the same PHY PDU, thereby advantageously designing resource assignment messages of a uniform format, so that the resource assignment messages have a fixed size which does not change dynamically with the number of segments, so as to reduce the workload of detecting the assignment messages by the MS and reduce complexity and cost of the MS.

Finally, it should be noted that the above embodiments are merely provided for describing the technical solutions of the present invention, but not intended to limit the present invention. It is apparent that persons skilled in the art can make various modifications and variations to the invention without departing from the scope of the invention. The present invention is intended to cover the modifications and variations provided that they fall in the scope of protection defined by the following claims or their equivalents.

What is claimed is:

1. A resource assignment method, comprising:
obtaining, by a Mobile Station (MS), combined indication information carried in a resource assignment message after the MS receives the resource assignment message;
judging whether a resource block indicated by resource assignment information in the resource assignment message is a segment of a Physical-layer (PHY) Protocol Data Unit (PDU) according to the combined indication information, and reading the segment of the corresponding PHY PDU according to the resource assignment information if the resource block is a segment of the PHY PDU;
combining segments belonging to a same PHY PDU into a complete PHY PDU, wherein the segments are read according to multiple received resource assignment messages; and
decoding the PHY PDU.

2. The resource assignment method according to claim 1, wherein:
the step of judging whether the resource block indicated by the resource assignment information in the resource assignment message is a segment of a PHY PDU according to the combined indication information comprises:
if the combined indication information is a combined indication field of at least two bits, judging whether the resource block indicated by the resource assignment information in the resource assignment message is a segment of a PHY PDU according to a value of the combined indication field.

3. The resource assignment method according to claim 2, wherein:
the step of combining segments belonging to the same PHY PDU into a complete PHY PDU, wherein the segments are read according to multiple received resource assignment messages comprises:
determining locations of the segments belonging to the same PHY PDU in the PHY PDU according to values of combined indication fields in the multiple resource assignment messages; and
combining the segments into a complete PHY PDU according to the locations.

4. The resource assignment method according to claim 1, wherein:
the step of judging whether the resource block indicated by the resource assignment information in the resource assignment message is a segment of a PHY PDU according to the combined indication information comprises:
if the combined indication information is subsequent segment indication information, judging whether the resource block indicated by the resource assignment information in the resource assignment message is a segment of a PHY PDU according to the subsequent segment indication information.

5. The resource assignment method according to claim 4, wherein:
the step of combining segments belonging to the same PHY PDU into a complete PHY PDU, wherein the segments are read according to multiple received resource assignment messages comprises:
according to transmission location of the resource assignment message corresponding to a next segment in a resource assignment channel, determining locations of segments belonging to the same PHY PDU in the PHY PDU, wherein the next segment is adjacent to the segment in the same PHY PDU and is indicated by the subsequent segment indication information in the multiple resource assignment messages; and
combining the segments into a complete PHY PDU according to the locations.

6. The resource assignment method according to claim 1, wherein:
the step of judging whether the resource block indicated by the resource assignment information in the resource assignment message is a segment of a PHY PDU according to the combined indication information comprises:
if the combined indication information is a combined indication field of one bit, judging whether the resource block indicated by the resource assignment information in the resource assignment message is a segment of a PHY PDU according to a value of the combined indication field.

7. The resource assignment method according to claim 1, wherein:
the step of judging whether the resource block indicated by the resource assignment information in the resource assignment message is a segment of a PHY PDU according to the combined indication information comprises:
if the combined indication information is Modulation Code Scheme (MCS) information in the resource assignment information in the resource assignment message, judging whether the resource block indicated by the resource assignment information in the corresponding resource assignment message is a segment of a PHY PDU according to whether MCS information in multiple resource assignment messages is the same.

8. The resource assignment method according to claim 1, wherein:
the step of combining segments belonging to the same PHY PDU into a complete PHY PDU, wherein the segments are read according to multiple received resource assignment messages comprises:
determining locations of corresponding segments in the PHY PDU to which the corresponding segments belong according to values of sorting indication fields respectively carried in the multiple received resource assignment messages; and
combining the segments into a complete PHY PDU according to the locations.

9. The resource assignment method according to claim 1, wherein:
the step of combining segments belonging to the same PHY PDU into a complete PHY PDU, wherein the segments are read according to multiple received resource assignment messages comprises:
determining locations of corresponding segments in the PHY PDU to which the corresponding segments belong according to a transmission sequence of the multiple resource assignment messages in the resource assignment channel; and
combining the segments into a complete PHY PDU according to the locations.

10. The resource assignment method according to claim 1, wherein:
the step of combining segments belonging to the same PHY PDU into a complete PHY PDU, wherein the segments are read according to multiple received resource assignment messages comprises:
using read segments borne respectively by multiple different carriers received simultaneously as segments belonging to the same PHY PDU;
determining the location of corresponding segment in the PHY PDU according to carrier number of each carrier and a location sequence or a logical number sequence of a time-frequency resource block of the corresponding carrier corresponding to the segment; and
combining the segments into a complete PHY PDU according to the locations.

11. The resource assignment method according to claim 1, wherein:
the step of combining segments belonging to the same PHY PDU into a complete PHY PDU, wherein the segments are read according to multiple received resource assignment messages comprises:
using multiple read segments borne by the same carrier as segments belonging to the same PHY PDU;
determining location of corresponding segment in the PHY PDU according to a location sequence or a logical number sequence of the time-frequency resource block of the carrier corresponding to the segment; and
combining the segments into a complete PHY PDU according to the locations.

12. The resource assignment method according to claim 1, wherein:
the step of combining segments belonging to the same PHY PDU into a complete PHY PDU, wherein the segments are read according to multiple received resource assignment messages comprises:
using read segments borne respectively by multiple different carriers received simultaneously as segments belonging to the same PHY PDU, where each carrier bears a segment;
determining locations of corresponding segments in the PHY PDU to which the corresponding segments belong according to carrier numbers of the corresponding carriers bearing the segments; and
combining the segments into a complete PHY PDU according to the locations.

13. The resource assignment method according to claim 12, wherein:
the step of determining the locations of the corresponding segments in the PHY PDU to which the corresponding segments belong according to a sequence of the carrier numbers of the corresponding carriers bearing the segments comprises:
stipulating beforehand, by the MS and a Base Station (BS), or negotiating through an air interface message dynamically to set a mapping relation between the carrier numbers of the carriers and the locations of the segments borne by the carriers in the PHY PDU to which the segments belong in a pre-stipulation mode or a dynamic negotiation mode by using an air interface message; and
determining the locations of the corresponding segments in the PHY PDU to which the corresponding segments belong according to the mapping relation.

14. The resource assignment method according to claim 1, wherein:
the step of combining segments belonging to the same PHY PDU into a complete PHY PDU, wherein the segments are read according to multiple received resource assignment messages and decoding the PHY PDU comprises:
combining the segments belonging to the same PHY PDU into complete PHY PDUs respectively in all possible arrangement sequences; and
decoding the PHY PDUs until one of the PHY PDUs is decoded successfully.

15. The resource assignment method according to claim 1, wherein:
the step of obtaining the combined indication information carried in the resource assignment message comprises:
obtaining scrambled data carried in the resource assignment message, wherein the scrambled data is formed after scrambling processing is performed on the combined indication information and an MS identifier (ID); and
the step of judging whether the resource block indicated by the resource assignment information in the resource assignment message is a segment of a PHY PDU according to the combined indication information comprises:
descrambling the scrambled data according to the MS ID and all possible values of the combined indication information; and
judging whether the resource block is a segment of the PHY PDU according to a value of the combined indication information used when the descrambling is completed successfully.

16. The resource assignment method according to claim 15, wherein:
the step of combining segments belonging to the same PHY PDU into a complete PHY PDU, wherein the segments are read according to multiple received resource assignment messages comprises:
determining locations of the segments belonging to the same PHY PDU in the PHY PDU according to the value of the combined indication information used when the descrambling is completed successfully; and
combining the segments into a complete PHY PDU according to the locations.

17. A Mobile Station (MS), comprising:
an obtaining module, configured to obtain combined indication information carried in a resource assignment message after the MS receives the resource assignment message;
a judging module, configured to judge whether a resource block indicated by resource assignment information in the resource assignment message is a segment of a Physical-layer (PHY) Protocol Data Unit (PDU) according to the combined indication information obtained by the obtaining module;
a reading module, configured to read the segment of the corresponding PHY PDU according to the resource assignment information if the indicated resource block is a segment of the PHY PDU according to a judgment result of the judging module;
a combining module, configured to combine segments belonging to a same PHY PDU into a complete PHY PDU, wherein the segments are read by the reading module according to multiple received resource assignment messages; and
a decoding module, configured to decode the PHY PDU combined by the combining module.

18. The MS according to claim 17, further comprising:
a negotiating module, configured to stipulate beforehand or negotiate with a Base Station (BS) through an air interface message dynamically to set a mapping relation between a carrier number of a carrier and a location of a segment borne by the carrier in the PHY PDU to which the segment belongs; wherein
the combining module is configured to determine the location of the corresponding segment in the PHY PDU to which the corresponding segment belongs according to the mapping relation, and combine the segments into a complete PHY PDU.
